(19) United States
(12) Patent Application Publication
(10) Pub. No.: US 2015/0235735 A1
(43) Pub. Date: Aug. 20, 2015

(54) SLEEVE SEAL

(71) Applicant: PHOENIX CONTACT GMBH & CO. KG, Blomberg (DE)

(72) Inventors: Andreas Schrader, Delbrueck (DE); Juergen Wegener, Oberscheinfeld (DE)

(21) Appl. No.: 14/428,328

(22) PCT Filed: Jul. 10, 2013
(86) PCT No.: PCT/EP2013/064529

§ 371 Date: Mar. 13, 2015

(30) Foreign Application Priority Data
Sep. 14, 2012 (DE) 102012216383.2

(51) Int. Cl. H01B 7/282; H02G 15/18; F16J 15/02

(52) U.S. Cl. CPC H01B 7/2825; F16J 15/022; H02G 15/18

(57) ABSTRACT

A sleeve seal for sealing a cable connection region for cables against moisture, having a sleeve housing that can be displaceably positioned over a cable connection region, and a sealing element for sealing the sleeve housing against moisture.

### FIELD OF THE INVENTION

The present invention relates to a sleeve seal for sealing a cable connection region of cables against moisture.

### RELATED TECHNOLOGY

Systems for sealing power supply cables on LED strips can have a structure such that a non-water-resistant LED strip present is mounted in a bar and connected by soldering or by means of a sleeve seal to corresponding connection cables. The water resistance for applications in the exterior region is then established by encapsulating the entire bar with a transparent composition. This procedure is expensive and relatively inflexible for a user, since the latter no longer can modify the water-resistant LED bar that has been prefabricated in this manner.

In other applications, the conductor connection of the LED strip can be protected by a shrink fit hose against splashing water. Here, the user needs to use a heat source in the form of a hot air apparatus in order to adapt the shrink hose to the conductor and the LED strip. In addition, water resistance is ensured only to a small extent, since moisture can still penetrate between the individual cables in the case of a multiple conductor connection.

With other water-resistant LED strips, the water-resistant conductor connection can be achieved in that the conductor for the power supply is connected to the flexible printed circuit board of the LED strip, and the connection area can be protected with a transparent sealing composition against the penetration of water. In this application as well, the installation cost is very high for the user. In addition, it takes time until the sealing composition is cured or crosslinked.

The printed publication DE 10 2008 034 956 A1 describes a connecting element for strip-shaped printed circuit boards fitted with lights for the formation of band-shaped and/or flat lamps. For the protection against water, the printed circuit boards can be arranged in transparent tubes.

### SUMMARY

The problem on which the invention is based is to make possible a water-resistant sealing for a cable connection, which can be produced without large expenditure.

This problem is solved by objects having the features according to the independent claims. Advantageous embodiments of the invention are the subject matter of the figures, the description and the dependent claims.

According to one aspect of the invention, the problem is solved by a sleeve seal for sealing a cable connection region of cables against moisture, having a sleeve housing which can be displaceably positioned over a cable connection region, and a sealing element for sealing the sleeve housing against moisture. The cables can be LED strips. As a result, for example, the technical advantage obtained is that a water-tight easily manufactured seal between two cables can be produced.

In an advantageous embodiment of the sleeve seal, the sealing element can be positioned or is positioned on an inner wall of the sleeve housing. As a result, for example, the technical advantage obtained is that a good sealing of the sleeve housing can be achieved.

In a further advantageous embodiment of the sleeve seal, the sealing element is a sealing sleeve which can be inserted into the sleeve housing or which is formed or molded, in particular injection molded, on an inner wall of the sleeve housing. As a result, for example, the technical advantage obtained is that a satisfactory sealing of the sleeve housing can be achieved and that the sleeve seal can be produced in a technically simple manner.

In an additional advantageous embodiment of the sleeve seal, the sealing element comprises a sealing sleeve body and a seal arranged on an inner wall of the sealing sleeve body. As a result, for example, the technical advantage obtained is that the seal can be improved even more.

In an additional advantageous embodiment of the sleeve seal, the seal comprises at least one partially peripheral resilient lamella or a plurality of at least partially peripheral resilient lamellas which are arranged one after the other. As a result, for example, the technical advantage obtained is that the lamellas prevent the penetration of water.

In an additional advantageous embodiment of the sleeve seal, the sealing element is open on both sides or on one side at the end faces. As a result, for example, the technical advantage obtained is that cables can be inserted into the sealing element from one side or from two sides.

In an additional advantageous embodiment of the sleeve seal, the sealing element has a first end face facing the interior of the sleeve housing and a second end face facing away from the interior of the sleeve housing, wherein the first end face is open and wherein the second end face is formed by a wall in which at least one opening for receiving a cable is provided. As a result, for example, the technical advantage obtained is that the sleeve housing can be used for sealing with respect to a cable.

In an additional advantageous embodiment of the sleeve seal, the sealing element is provided for sealing a first section of the sleeve housing, and an additional sealing element is provided for sealing a second section of the sleeve housing. As a result, for example, the technical advantage obtained is that a two-sided seal with respect to a cable is achieved.

In an additional advantageous embodiment of the sleeve seal, the sections are arranged so that they face one another. As a result, for example, the technical advantage obtained is that the sleeve seal seals from the two sides.

In an additional advantageous embodiment of the sleeve seal, the sealing element and the additional sealing element can be inserted laterally on mutually facing sides into the sleeve housing or are formed or molded, in particular injection molded, on an inner wall of the sleeve housing. As a result, for example, the technical advantage obtained is that the sleeve seal can be assembled and can be produced in a technically simple manner.

In an additional advantageous embodiment of the sleeve seal, the additional sealing element comprises a sealing sleeve body and a seal arranged on an inner wall of the sealing sleeve body. As a result, for example, the technical advantage is also obtained that the seal can be improved even more.

In an additional advantageous embodiment of the sleeve seal, the sleeve housing has a rectangular cross section, in particular a rectangular cross section with rounded corners. As a result, for example, the technical advantage obtained is that a twisting of the housing in difficult installation situations is prevented.

In an additional advantageous embodiment of the sleeve seal, the sleeve housing and the respective sealing element are molded out of plastic. As a result, for example, the technical advantage obtained is that the housing can be produced in a technically simple manner.

In an additional advantageous embodiment of the sleeve seal, the sleeve housing is transparent. As a result, for example, the technical advantage obtained is that LEDs located in the interior of the sleeve housing shine through and the noticeability of the sleeve seal is reduced.

According to a second aspect, the problem is solved by a cable arrangement with a first cable, in particular with an LED strip cable, and a second cable, which are electrically connected to one another in a connection region; and with a sleeve seal according to the first aspect for sealing the connection region against moisture. As a result, the same technical advantages are obtained as with the sleeve seal according to the first aspect.

### BRIEF DESCRIPTION OF THE DRAWINGS

Embodiment examples of the invention are represented in the drawings and described in further detail below.

FIG. 1 shows a perspective view of a sleeve seal with inserted cable and LED strip;

FIG. 2 shows a perspective view of the sleeve seal with separated cable and LED strips;

FIG. 3 shows a perspective view of the sleeve seal from the side for the insertion of the LED strip;

FIG. 4 shows a perspective view of the sleeve seal from the side for the insertion of the cable;

FIG. 5 shows a perspective view of the components of the sleeve seal; and

FIG. 6 shows a sleeve seal for the connection of two LED strips.

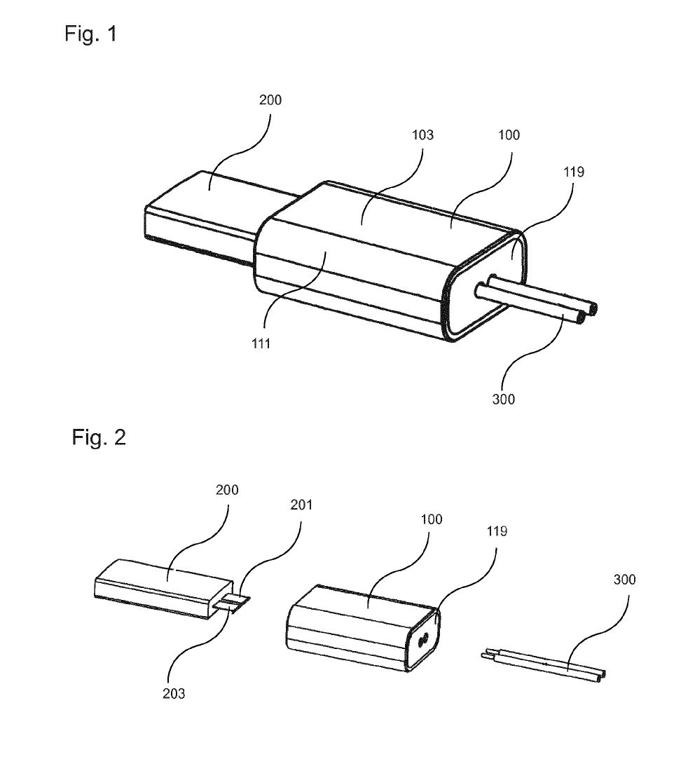

### DETAILED DESCRIPTION

The LED strip 200 comprises a band- or a strip-shaped substrate on which a plurality of light emitting diodes are arranged. At the end of the substrate, two contacts are arranged, by means of which the individual light emitting diodes can be supplied with energy.

The substrate can be formed, for example, from a flexible plastic band. LED strips are suitable for a space-saving lamp for a small space. Since LEDs generate hardly any heat, the use of the LED strips for indirect lighting used directly in furniture is also possible.

The sleeve seal 100 comprises a cuboid sleeve housing 103, which has beveled or rounded longitudinal edges 111, for example, a plastic sleeve. The sleeve housing 103 encloses the LED strip 200 at its connecting end and it allows a water-resistant sealing of a connection or of a connection region of the LED strip.

The sleeve housing 103 comprises a sealing element 119 for the sealed introduction of cables 300 into the sleeve housing 103. The cables 300 are connected to the electrical connections of the LED strip and are used for energy and power supply. By means of the sleeve seal 100, handling can be improved for producing a water-resistant seal of LED strip terminals and connections.

The sleeve housing 103 is inserted by a user via the terminal or connection site of the LED strip. In the process, the water-resistant seal between the sleeve housing 103 and the flexible water-resistant LED strip 200 and with respect to the cables 300 is established by means of corresponding sealing elements. The sleeve housing 103 can be implemented so as to be transparent so that LEDs in the connection region are also not concealed by the sleeve housing 103. In addition, visual verification, by a user, of the correct position of the sleeve housing 103 relative to the LED strip 200 is made possible. The sealing element 119 can be implemented so as to be transparent or non-transparent.

FIG. 2 shows a perspective view of the sleeve seal 100 with separated cable 300 and LED strip 200. The cable 300 is led from the one side into the sleeve seal 100 with the sealing element 119. The LED strip with the electrical connections 201 and 202 is led from the other side into the sleeve housing 103. The sleeve housing 103 encloses the electrical connection between the cable 300 and the LED strip 200.

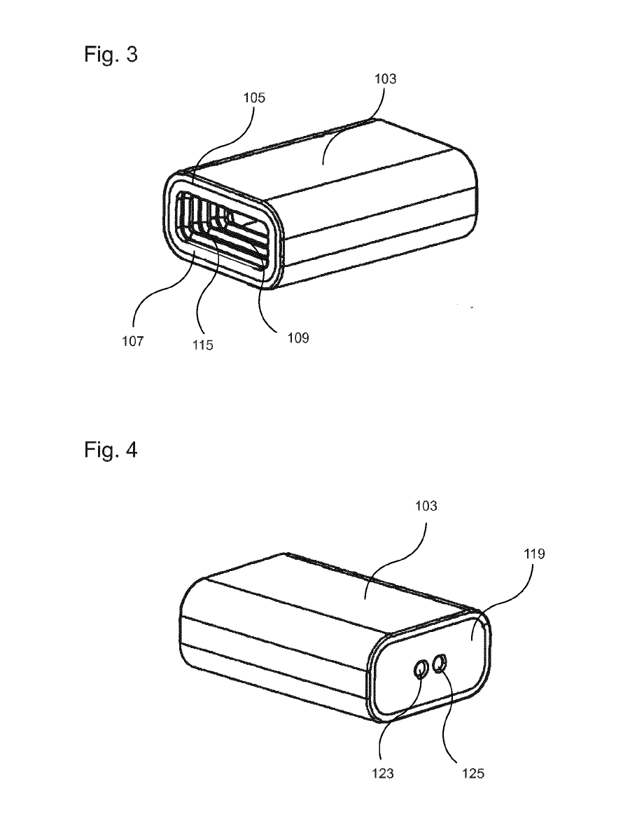

FIG. 3 shows a perspective view of the sleeve seal 100 from the side for the insertion of the LED strip 200. The sleeve housing 103 has a housing opening 105 for the positive-lock reception of the sealing element 107. The sealing element 107 fills the gap between the LED strip 200 and the sleeve housing 103 and is used for sealing a connection region for the LED strip 200.

The sealing element 107 has a seal opening 109 having a rectangular cross section into which the LED strip can be inserted. On the inside of the seal opening 109, peripheral lamellas 115 are located, which rest on the LED strip as it is inserted. By means of these lamellas 115, the connection to the LED strip can be sealed in a particularly effective manner, so that the entry of water is prevented. The lamellas 115 can have a wedge-shaped cross-sectional shape, for example.

The sealing element 107 can be made of a resilient transparent material such as, for example, transparent silicone, so as not to conceal any LEDs. The sealing element 107 can be injected molded on the sleeve housing 103 or it can be in the form of a separate part.

FIG. 4 shows a perspective view of the sleeve seal 100 from the side for the insertion of the cable 300. For the introduction of the cable 300, the sealing element 119, which has two openings 123 and 125 for the introduction of the cable 300, is used. The sealing element 119 can be inserted into the sleeve housing 103 from the side facing the side with the sealing element 107. The sealing element 119 is designed in such a manner that penetration of water along the cable 300 is prevented. For this purpose, the sealing element 119 can be made of a transparent or nontransparent resilient material.

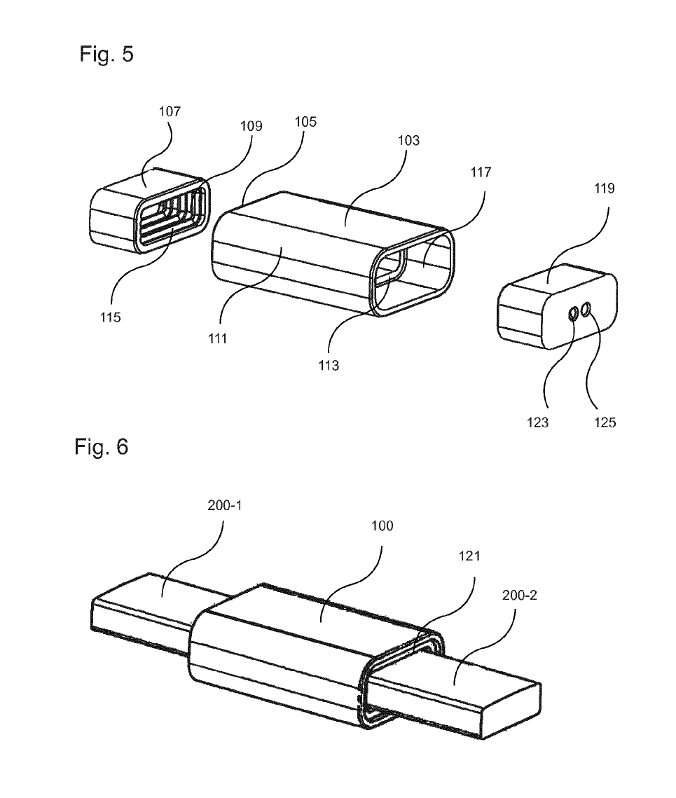

FIG. 5 shows a perspective view of individual components of the sleeve seal 100. On the one side of the sleeve housing 103, the sealing element 107 with the seal opening 109 and the peripheral lamellas 115 is introduced into the sleeve housing opening 105. On the other side of the sleeve housing 103, the sealing element 119 with the openings 123 and 125 is introduced into the sleeve housing opening 117. In the interior, the sleeve housing has a respective stop edge 113 against which the sealing element 119 or the sealing element 107 abuts at the time of the insertion. The sleeve housing 103 therefore has a stop edge for the formation of a stop at the time of the insertion of a sealing element 107, 121 or 119. As a result, for example, the technical advantage obtained is that the sealing element can be positioned exactly inside the housing. The sleeve housing 103 moreover can comprise a catch means for engagement in a sealing element. As a result, the installation of the sleeve seal 100 can be simplified.

FIG. 6 shows a sleeve seal 100 for the connection of two LED strips 200-1 and 200-2. For this purpose, on the right side of the sleeve housing 103 a first sealing element 107 and on the other side of the sleeve housing 103 a second sealing element 121 are arranged. The second sealing element 121 corresponds to the first sealing element 107. As a result, a water-resistant connection between two LED strips can be established.

The sealing system for a water-resistant LED strip connection comprises a sleeve housing 103 and, depending on the application case, either two sealing elements 107 and 121 for sealing the connection region between two LED strips 200-1 and 200-2 or a sealing element 107 for sealing the connection region for the LED strip and a sealing element 119 for sealing the connection region for the cable 300.

The sealing elements 107, 121 and 119 can be injected molded undetachably on the sleeve housing 103. However, the sealing elements 107, 121 and 119 can also be present in addition to the sleeve housing 103 as separate parts, which allows a flexible installation by a user. The sleeve housing 103 can be manufactured from a transparent plastic. The sealing elements 107 and 121 can be produced from a transparent or translucent resilient material. The sealing element 119 can be manufactured from a transparent or translucent, resilient material or a nontransparent, resilient material. However, in general, all other materials having any desired optical properties that are suitable for the formation of the respective elements can also be used.

All the features explained and shown in connection with individual embodiments of the invention can be provided in different combinations in the object according to the invention in order to simultaneously implement their advantageous effects.

The scope of protection of the present invention is given by the claims and not limited by the features explained in the description or shown in the figures.

### LIST OF REFERENCE NUMERALS

100 Sleeve seal

103 Sleeve housing

105 Housing opening

107 Sealing element

109 Seal opening

111 Longitudinal edges

113 Stop edge

115 Lamellas

117 Housing opening

119 Sealing element

121 Sealing element

123 Opening

125 Opening

200 LED strip

200-1 LED strip

200-2 LED strip

201 Electrical connection

202 Electrical connection

300 Cable

1. A sleeve seal for sealing a cable connection region of cables against moisture, having:
a sleeve housing which can be displaceably positioned over a cable connection region; and
a sealing element for sealing the sleeve housing against moisture.

2. The sleeve seal according to claim 1, wherein the sealing element can be positioned or is positioned on an inner wall of the sleeve housing.

3. The sleeve seal according to claim 1, wherein the sealing element is a sealing sleeve which can be inserted into the sleeve housing or which is formed or molded, in particular injection molded, on an inner wall of the sleeve housing.

4. The sleeve seal according to claim 3, wherein the sealing element comprises a sealing sleeve body and a seal arranged on an inner wall of the sealing sleeve body.

5. The sleeve seal according to claim 4, wherein the seal comprises an at least partially peripheral resilient lamella or a plurality of at least partially peripheral resilient lamellas which are arranged one after the other.

6. The sleeve seal according to claim 1, wherein the sealing element is open on both sides or on one side at an end face.

7. The sleeve seal according to claim 1, wherein the sealing element has a first end face facing an interior of the sleeve housing and a second end face facing away from the interior of the sleeve housing, wherein the first end face is open and wherein the second end face is formed by a wall in which at least one opening for receiving a cable is provided.

8. The sleeve seal according to claim 1, wherein the sealing element is provided for sealing a first section of the sleeve housing, and wherein an additional sealing element is provided for sealing a second section of the sleeve housing.

9. The sleeve seal according to claim 8, wherein the sections are arranged so that they face one another.

10. The sleeve seal according to claim 8, wherein the sealing element and the additional sealing element can be inserted laterally on mutually facing sides into the sleeve housing or are formed or molded, in particular injection molded, on an inner wall of the sleeve housing.

11. The sleeve seal according to claim 1, wherein the additional sealing element comprises a sealing sleeve body and a seal arranged on an inner wall of the sealing sleeve body.

12. The sleeve seal according to claim 1, wherein the sleeve housing has a rectangular cross section, in particular a rectangular cross section with rounded corners.

13. The sleeve seal according to claim 1, wherein the sleeve housing and the respective sealing element are formed out of plastic.

14. The sleeve seal according to claim 1, wherein the sleeve housing is transparent.

15. A cable arrangement, having:
a first cable, in particular an LED strip cable, and a second cable, which are electrically connected to one another in a connection region; and
a sleeve seal for sealing the connection region against moisture having:
a sleeve housing which can be displaceably positioned over a cable connection region, and
a sealing element for sealing the sleeve housing against moisture.

16. The cable arrangement according to claim 15, wherein the sealing element can be positioned or is positioned on an inner wall of the sleeve housing.

17. The cable arrangement according to claim 15, wherein the sealing element is a sealing sleeve which can be inserted into the sleeve housing or which is formed or molded, in particular injection molded, on an inner wall of the sleeve housing.

18. The cable arrangement according to claim 17, wherein the sealing element comprises a sealing sleeve body and a seal arranged on an inner wall of the sealing sleeve body.

19. The cable arrangement according to claim 18, wherein the seal comprises an at least partially peripheral resilient lamella or a plurality of at least partially peripheral resilient lamellas which are arranged one after the other.

20. The cable arrangement according to claim 15, wherein the sealing element is open on both sides or on one side at an end face.

21. The cable arrangement according to claim 15, wherein the sealing element has a first end face facing an interior of the sleeve housing and a second end face facing away from the interior of the sleeve housing, wherein the first end face is open and wherein the second end face is formed by a wall in which at least one opening for receiving a cable is provided.

22. The cable arrangement according to claim 15, wherein the sealing element is provided for sealing a first section of the sleeve housing, and wherein an additional sealing element is provided for sealing a second section of the sleeve housing.

23. The cable arrangement according to claim 22, wherein the sections are arranged so that they face one another.

24. The cable arrangement according to claim 23, wherein the sealing element and the additional sealing element can be inserted laterally on mutually facing sides into the sleeve housing or are formed or molded, in particular injection molded, on an inner wall of the sleeve housing.

25. The cable arrangement according to claim 15, wherein the additional sealing element comprises a sealing sleeve body and a seal arranged on an inner wall of the sealing sleeve body.

26. The cable arrangement according to claim 15, wherein the sleeve housing has a rectangular cross section, in particular a rectangular cross section with rounded corners.

27. The cable arrangement according to claim 15, wherein the sleeve housing and the respective sealing element are formed out of plastic.

28. The cable arrangement according to claim 15, wherein the sleeve housing is transparent.
